(19) United States
(12) Patent Application Publication
(10) Pub. No.: US 2008/0298661 A1
(43) Pub. Date: Dec. 4, 2008

(54) Method and Apparatus for Parameter Free Regularized Partially Parallel Imaging Using Magnetic Resonance Imaging

(76) Inventor: Feng Huang, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/114,704

(22) Filed: May 2, 2008

Related U.S. Application Data
(60) Provisional application No. 60/927,541, filed on May 2, 2007.

(51) Int. Cl. G06K 9/00

(52) U.S. Cl. 382/131

(57) ABSTRACT

Embodiments of the invention are directed to a method and apparatus for parameter free regularized partially parallel imaging (PPI). Specific embodiments relate to a method and apparatus for high pass GRAPPA (hp-GRAPPA), doubly calibrated GRAPPA (db-GRAPPA), and/or image ratio constrained reconstruction (IRCR). The subject techniques can be applied individually or in combination. In a specific application of an embodiment of the subject method, hp-GRAPPA is used to reconstruct high frequency information, and db-GRAPPA is used reconstruct low frequency information regularized with prior information. In another specific application of an embodiment of the subject method, the result of IRCR a regularization term for db-GRAPPA. Experiments demonstrate that the results obtained by implementing embodiments of the subject method have significantly higher SNR than results obtained utilizing un-regularized techniques and have higher spatial resolution and/or lower error than results obtained using regularized SENSE. The subject double calibration technique lessens the motion problem of the pre-scan even when significant structure change occurs. High quality images generated by a specific embodiment of the subject double calibration technique are demonstrated with a net reduction factor as high as 4.8.

### CROSS-REFERENCE TO RELATED APPLICATION

The present application claims the benefit of U.S. Application Ser. No. 60/927,541, filed May 2, 2007, which is hereby incorporated by reference herein in its entirety, including any figures, tables, or drawings.

### BACKGROUND OF INVENTION

Regularized partially parallel imaging (PPI) techniques produce images with higher signal-to-noise (SNR) than those produced using un-regularized PPI. However, the determination of regularization parameters can be computationally expensive and regularization can lead to substantial errors if the parameters are incorrectly chosen. When a low-resolution image is used as the regularization term, the spatial resolution of the reconstruction also tends to be low. Furthermore, if the pre-scan is used for regularization, the patient motion in between the pre-scan and the true acquisition data may cause significant error. Accordingly, there is a need for parameter-free regularized PPI that can operate without significant error.

For many applications of magnetic resonance imaging (MRI), the scan time reduction is crucial. One approach to reduce the scan time is to reduce the number of acquired phase-encoding (PE) lines by a given factor, typically called the reduction factor. Reconstruction can then be achieved using partially parallel imaging (PPI) techniques (1-3). In principal, PPI can provide an unlimited reduction in acquisition time, although in reality it is limited by the number of channels. In addition, for a high reduction factor, the signal to noise ratio (SNR) is severely degraded. With the application of regularization techniques, the SNR can be dramatically increased even with high reduction factor. Many of the advantages of regularized PPI techniques are detailed in references (4-10).

Depending on the constraints used, regularization techniques can be divided into three categories. The first category uses pre-conditioning techniques to artificially reduce the condition number of the inverse matrix, and thus minimize noise exaggeration. One approach for the implementation is to use diagonal loading, also called ridge regression and matrix regularization. This approach has been used in SMASH (5) and SENSE (11, 12). Another approach is to use truncated singular value decomposition (TSVD), a method used by Sodickson et. al. for generalized parallel imaging (6), and by Qu et. al. for GRAPPA (13). The methods in this category do not require prior regularization information; however require a regularization parameter to balance SNR and artifact suppression.

The second category of methods uses prior regularization information. For all PPI techniques, sensitivity information is commonly used to get this information. Typically, either a pre-scan or an auto calibration signal (ACS) is acquired. These low-resolution images provide not only the sensitivity information but also the intensity information. It is reasonable to use the intensity information as prior information for regularization and the majority of the prior information based regularization techniques (4, 7-9) use Tikhonov regularization (14). Instead of the low-resolution images themselves, the feedback regularization method proposed in references (4, 7) uses the result of the first regularization method (4) or previous iteration (7) as prior information. In all of these methods, a regularization parameter is used to balance the data fidelity (model error) and the similarity to the prior regularization information (prior error).

Methods in the third category (10, 15) use the conjugate symmetry property of k-space data of MRI, based on the assumption that the reconstructed image is real. Again, there is a regularization parameter to strengthen/weaken the constraint. A method proposed in reference (15) does not use any such parameter and forces the imaginary part to be 0; however, this is likely to cause artifacts at the regions of fast phase variations within the image (10).

Two different approaches were used to determine the regularization parameter, which is important in all regularization methods. One approach is to use an empirical value (5, 10, 11); the other approach is to calculate the parameter (12, 13). To decide the empirical value, numerous experiments are necessary for each particular application. The regularization parameter can also be calculated using the Discrepancy principle (13) or L-curve method (8). However, it would require repeated trials with different parameters and the calculation of the errors for each of the parameters used. Hence the computational time is expected to be long (8), although the time consumption was not reported in reference (13). Also, the details of calculation methods of the adaptive regularization approach was not reported in reference (12), hence, the complexity of this calculation is not clear. However, the parameters for each single pixel need to be calculated separately and this would tend to increase the computational time.

Accordingly, regularized PPI techniques can generate high quality images with high reduction factors, but the determination of the required regularization parameter can be difficult. Parameter free regularization approaches can also be used. Prior calibration information has been used for regularization (7-9). The prior information can be either from a pre-scan or an auto-calibration-signal. If the ACS lines are used to generate the low-resolution calibration image, the spatial resolution could be too low. The resultant reconstruction will then also have low spatial resolution. Accordingly, there is a need to minimize the spatial resolution loss when ACS lines are used. If prior information other than self-calibration data (ACS lines) is used, it is possible that there is motion between the calibration image and the true image. The direct use of an inaccurate calibration image may cause serious errors in the reconstruction (8). Hence, there is a need for registration of the calibration image and the true image. The proposed method avoids the presented drawbacks of the prior arts.

### BRIEF SUMMARY

Embodiments of the invention are directed to a method and apparatus for parameter free regularized partially parallel imaging (PPI). Specific embodiments relate to a method and apparatus for high pass GRAPPA (hp-GRAPPA), doubly calibrated GRAPPA (db-GRAPPA), and/or image ratio constrained reconstruction (IRCR). The subject techniques can be applied individually or in combination. In a specific application of an embodiment of the subject method, hp-GRAPPA is used to reconstruct high frequency information, and db-GRAPPA is used reconstruct low frequency information regularized with prior information. In another specific application of an embodiment of the subject method, the result of IRCR a regularization term for db-GRAPPA. Experiments demonstrate that the results obtained by implementing embodiments of the subject method have significantly higher SNR than results obtained utilizing un-regularized techniques and have higher spatial resolution and/or lower error than results obtained using regularized SENSE. The subject double calibration technique lessens the motion problem of the pre-scan even when significant structure change occurs. High quality images generated by a specific embodiment of the subject double calibration technique are demonstrated with a net reduction factor as high as 4.8.

Methods and apparatus in accordance with embodiments of the invention can dramatically improve the performance of partially parallel imaging techniques without increasing reconstruction time. Embodiments of the subject method and apparatus can also solve the registration problem caused by the image difference between the calibration image based on the pre-scan and the true acquisition due to, for example, motion of the subject between the pre-scan and the true acquisition.

Embodiments of the invention can address one or more problems existing with current regularization techniques. With the direct use of the low-resolution image itself, the reconstruction using regularization can result in a loss of resolution. In a specific embodiment, the regularization parameter determination can be made utilizing ACS lines. Using the low-resolution image to reduce image support and adding the low resolution image back after GRAPPA to compensate the reduced image support can reduce or eliminate the reduction of spatial resolution. In this way, the time for calculation can be reduced by using this method. The registration problem between calibration image and true image can be partially solved by using a double calibration technique, which is a parameter free technique, in accordance with an embodiment of the invention. Embodiments implementing a fully automatic parameter free technique can save the time-consuming calculation for a regularization parameter. With respect to embodiments using a regularization term, the SNR of the result can be significantly higher than the SNR obtained by existing PPI techniques. Although existing regularization techniques can also increase SNR, a corresponding reduction in spatial resolution exists, even with a carefully chosen regularization parameter. Embodiments of the subject method can achieve spatial resolution for images that is almost identical to the spatial resolution for traditional PPI, while achieving a higher SNR. The self-calibration technique can solve the registration problem with pre-scans, but reduces the net reduction factor. The double calibration technique can dramatically reduce the artifacts caused by self-calibration technique, while further increasing net reduction factor. In an embodiment, the number of ACS lines can be as small as reduction factor minus one. These techniques are particularly advantageous for applications that need both high SNR and high speed.

Embodiments incorporating the subject techniques can be used to dramatically improve the image quality for partially parallel imaging (PPI) techniques that use calibration data. Calibration data can be achieved, for example, from either ACS lines or a pre-scan. If ACS lines are used for calibration, then the hp-GRAPPA can be used to significantly increase SNR without losing much spatial-resolution. If pre-scan is used for calibration, then the doubly calibrated hp-GRAPPA, optionally in conjunction with hp-GRAPPA, can be applied to increase SNR without losing spatial-resolution, and without serious errors caused by the difference between the pre-scan image and true acquisition image. Techniques in accordance with embodiments of the invention can update existing PPI products for better image quality and/or higher reduction factor.

Embodiments of the invention can incorporate parameter free regularized PPI. Considering the determination of regularization parameters, the subject method can have advantages over existing techniques. Embodiments incorporating the parameter determination with ACS technique and/or the double calibration techniques can automatically calculate the regularization parameter. Hp-GRAPPA has two parameters to define the filter. However, one parameter can be decided by the number of ACS lines and the other one can be fixed. Hence, compared to the existing regularization techniques with empirical parameters, embodiments of the subject method can be more flexible. Compared to the existing regularization techniques with calculated parameters, embodiments of the subject method can require significantly less computation for parameter determination.

The image quality of the images reconstructed by embodiments of the subject method, can have additional advantages. The spatial resolution of the results by hp-GRAPPA, and db-GRAPPA is identical to these using GRAPPA with higher SNR. Hp-GRAPPA is preferred when there are no pre-scan data. When there are data acquired in pre-scan with the same acquisition parameters but in low-resolution, the db-GRAPPA can be used. The spatial resolution of the results using doubly calibrated GRAPPA is much higher than by using regularized SENSE. Moreover, the SNR of the results using db-GRAPPA is much higher than that by using GRAPPA. More importantly, the double calibration technique reduces the registration problem between pre-scan and true acquisition. Even if the structure changes significantly (FIG. 5), the second calibration can still detect the change and accurately balance the model error and regularization error. To the contrary, the result using regularized SENSE can have significant error (FIG. 5c). The experiments presented in the Examples herein show a difficult example of motion, which is non-rigid. If body translation occurs, which is rigid, the second calibration can solve the problem even more accurately. Because the translation in image space is simply a phase shifting in k-space, this change can be corrected by the multiplication with a constant, which can be calculated by the second calibration.

In an embodiment, the result of image ratio constrained reconstruction (IRCR) is used as an example of a regularization term and GRAPPA is used as an example of PPI. In additional embodiments, the regularization term can be other than the result of IRCR. Any regularization information can be modified to be the regularization term used in accordance with the subject invention. In various embodiments, hp-GRAPPA, dp-GRAPPA, and IRCR can each be used individually or in various combinations.

Dynamic cardiac images are presented in this application to aid in describing various embodiments and illustrating the advantages of the subject invention. However, the subject invention is not limited to cardiac imaging or to dynamic imaging. The dynamic cardiac image data sets provide relevant examples. Embodiments of the invention have also been applied to brain anatomy images and abdomen images and have produced images with higher SNR than images produced using un-regularized methods without noticeable loss of spatial-resolution. Regularized SENSE is an excellent algorithm and suitable for some applications, such as fMRI, when there is not much difference between the calibration image and the true image. However, it may have some limitation for applications with severe motion.

In the experiments presented in the examples provided herein, the central k-space data from other time frames are used as pre-scan data to illustrate the double calibration technique. A data set with actual pre-scan data can also be utilized in accordance with an embodiment of the invention. Additional embodiments of the invention involve applying the inventions to non-Cartesian trajectories.

### BRIEF DESCRIPTION OF DRAWINGS

FIGS. 1A-1F show an example of hp-GRAPPA with the axial brain image. Acceleration factor was 4, and 56 ACS lines were used for calibration. c=24, and w=6 were used in the high pass filter. a: the reference image, the white box shows the location of zoomed in region; c and e: the images reconstructed by hp-GRAPPA and GRAPPA; b, d, and f: the zoomed in image of the left column

FIGS. 2A-2E show a comparison of db-GRAPPA with GRAPPA and regularized SENSE when there is no mis-registration between prior information and target image. Cine cardiac function data are used in this example. Net reduction factor is 3.3. FIG. 2A shows the reference image, the white box shows the ROI; FIG. 2B shows the ROI of the reference image;

FIG. 2C shows the reconstruction by GRAPPA (relative error 21.7%); FIG. 2D shows the reconstruction by filtered db-GRAPPA (relative error 12.1%); FIG. 2E shows the reconstruction by regularized SENSE (relative error 20.4%).

FIGS. 3A-3H show a comparison of db-GRAPPA with GRAPPA and regularized SENSE when there is mis-registration between prior information and target image. Cine cardiac function images are used in this example. Net reduction factor is 4.8. FIG. 3A shows the ROI of the pre-calibration image; FIG. 3B shows the ROI of the reference image of time frame 6; FIG. 3C shows the ROI of the reconstruction by regularized SENSE (relative error 25.5%); FIG. 3D shows the ROI of the reconstruction by db-GRAPPA (relative error 14.7%); FIG. 3E shows the ROI of the reconstruction by GRAPPA with convolution kernel calculated from the pre-calibration data (relative error 21.8%); FIG. 3F shows the difference map of the reconstruction by regularized SENSE FIG. 3G shows the difference map of the reconstruction by doubly calibrated UNWRAP-GRAPPA; FIG. 3H shows the difference map of the reconstruction by GRAPPA. The difference maps (—FIGS. 3F, 3G, and 3H) are brightened 5 times and in the same intensity scale.

FIGS. 4A-4D show an example of IRCR when there is no geometry change between calibration image and the target image. FIG. 4A shows the calibration image of channel 6; FIG. 4b shows the reference image of channel 5. FIGS. 4A and 4B are reconstructed with 512 projections (PR); FIGS. 4C and 4D show images reconstructed with 8 and 16 PR. Only the region-of-interests (ROI) are shown. It can be seen that the image reconstructed with only 8 projections has the same spatial resolution as the one reconstructed with 512 PR. In addition, no obvious artifact is present.

FIGS. 5A-5D show an example of IRCR when there is geometry change between calibration image and the target image. FIG. 5a shows the ROI of the calibration image with 256 PR. FIGS. 5B-5D show the results of time frame 13. FIG. 5B is the ROI of the reference image reconstructed with 256 PR. FIGS. 5c and 5d show the ROI and whole image region of the image reconstructed with 32 PR.

FIG. 6A-6D show an example of db-GRAPPA regularized by the result of IRCR with radial trajectory. FIG. 6A shows the reference image reconstructed with 256 PR; FIGS. 6B-6D show the image reconstructed by GRAPPA, IRCR, and db-GRAPPA regularized by the results of IRCR.

FIG. 7 shows the plot of relative errors at ROI of images reconstructed by GRAPPA (solid line), IRCR (dotted line), and db-GRAPPA regularized by the results of IRCR (dashed line) of each time frame and demonstrates that the proposed db-GRAPPA generated images with the lowest error at all time frames.

### DETAILED DISCLOSURE

Embodiments of the invention are directed to a method and apparatus for parameter free regularized partially parallel imaging (PPI). Specific embodiments relate to a method and apparatus for high pass GRAPPA (hp-GRAPPA), doubly calibrated GRAPPA (db-GRAPPA), and/or image ratio constrained reconstruction (IRCR). The subject techniques can be applied individually or in combination. In a specific application of an embodiment of the subject method, hp-GRAPPA is used to reconstruct high frequency information, and db-GRAPPA is used reconstruct low frequency information regularized with prior information. In another specific application of an embodiment of the subject method, the result of IRCR a regularization term for db-GRAPPA. Experiments demonstrate that the results obtained by implementing embodiments of the subject method have significantly higher SNR than results obtained utilizing un-regularized techniques and have higher spatial resolution and/or lower error than results obtained using regularized SENSE. The subject double calibration technique lessens the motion problem of the pre-scan even when significant structure change occurs. High quality images generated by a specific embodiment of the subject double calibration technique are demonstrated with a net reduction factor as high as 4.8.

To address the problem of low spatial resolution when ACS lines are used to generate the low-resolution calibration image, an embodiment can incorporate a technique that can be referred to as “parameter determination with ACS”. In accordance with an embodiment utilizing parameter determination with ACS, the regularization parameter is calculated by fitting ACS lines in k-space. The calculation is similar to the convolution kernel determination in GRAPPA (3), which is incorporated herein by reference in its entirety. A specific embodiment of parameter determination with ACS is fast and parameter free.

To address the problem of spatial resolution loss when ACS lines are used, an image support reduction technique can be used. This technique is an approach to reduce artifacts/noises in reconstruction with partial acquisition when ACS lines are available. Using this technique the high frequency information and the low frequency information are reconstructed separately. There are two parameters in the filter to implement image support reduction. However, these two parameters can be predefined. If the data from a pre-scan is available, a technique that can be referred to as the double calibration technique can be used to take advantage of the prior information provided by the pre-scan and increase the net reduction factor, while avoiding the error caused by the motion between the pre-scan and true acquisition. This double calibration technique can be fully automatic and can be used to reduce or eliminate the registration problem.

In the following section, three techniques relating to parameter regularization, which can be referred to as image support reduction (hp-GRAPPA), parameter determination with ACS for regularized GRAPPA, and double calibration (db-GRAPPA), are described. To provide regularization term with non-Cartesian trajectory, IRCR is also introduced. The subject techniques are then combined together and the results compared with the exiting techniques. The advantages of the subject methods are demonstrated with these comparisons.

High Pass GRAPPA (hp-GRAPPA)

Image support reduction techniques (16, 17) provide approaches to artificially reduce the image support before reconstruction. The rationale behind these techniques is that a sparser image is easier to reconstruct with partially acquired data. For dynamic imaging, the image support can be reduced by subtracting the invariant signal along time direction from each time frame. For static imaging with ACS lines, the high frequency information and low-frequency information can be reconstructed separately. The low-frequency information is mainly contained in the ACS lines. The high frequency information has reduced image support and can be reconstructed separately. The final reconstruction is the summation of reconstruction of ACS lines and the reconstruction of high-frequency information. Because most of the contrast information is contained in low frequency information, the reconstruction of only high frequency information will typically have less residual aliasing. For implementation of image support reduction, a high pass filter can be applied to the partially acquired k-space data, which corresponds to an image with suppressed image contrast, and then GRAPPA is applied on the support reduced image. The reconstructed image is projected back into k-space and filtered by the inverse of that high pass filter to generate the full k-space data corresponding to the original image. Finally, the acquired data is used to substitute the reconstructed k-space data at acquired k-space locations to generate the final reconstruction through Fourier transform.

In an embodiment, 1-FK is used as the high pass filter, where

$$FK = {( 1 + {e}^{( \sqrt{{k}_{x}^{2} + {k}_{y}^{2}} - c ) / w} )}^{- 1} - {( 1 + {e}^{( \sqrt{{k}_{x}^{2} + {k}_{y}^{2}} + c ) / w} )}^{- 1} \qquad [ 1 ]$$

where k_{y} is the count of phase encode (PE) lines, c and w are two parameters to adjust the filter. The parameter c sets the cut-off frequency and the parameter w determines the smoothness of the filter boundary. In a specific embodiment, the value of c equals to the minimum of 13 and a quarter of the number of ACS lines, and w equals to 2. Experiments have shown that the reconstruction result to not be improved significantly by using parameters other than the value provided above. An embodiment have the parameters determined by the number of ACS lines for all applications can be treated as a parameter free technique.
Regularized GRAPPA with Automatically Decided Regularization Parameters

With respect to auto-calibration (3, 18), all of the required information for reconstruction can be approximated by fitting the ACS lines. This can be used to determine the regularization parameter. As an example, the combination of prior information and GRAPPA is used to demonstrate the idea of the parameter determination with ACS technique. An embodiment of this technique can be implemented by performing the following:

1. Generate initial reconstruction or prior information of each channel.

2. Project the initial reconstruction into k-space to generate the initial full k-space data \hat{K}^{j} for each channel (Fast Fourier transform);

3. Calculate the information required for reconstruction (convolution kernels, regularization parameter, etc) by data-fit of the ACS lines using both of the initial full k-space data and the partial k-space data from each channel. The process of fitting data in coil j at a line k_{y}−mΔk_{y} offset from the normally acquired data is

$${K}^{j} ( {k}_{y} - m Δ {k}_{y} ) = {\sum }_{t = 1}^{{N}_{c}} ( \begin{matrix}{\sum }_{b = 0}^{{N}_{b} - 1} n ( j , b , t , m ) {K}^{j} ( {k}_{y} - bR Δ {k}_{y} ) + \\ n ( j , {N}_{b} , t , m ) {\hat{K}}^{j} ( {k}_{y} - m Δ {k}_{y} )\end{matrix} ) . \qquad [ 2 ]$$

N_{b} is the number of blocks used in the reconstruction, where a block is defined as a single acquired line and R−1 missing lines. In this case, n(j, b, t, m) generated by fitting the ACS lines, represents the weights used in this now expanded linear combination. Here, the index t denotes the individual coils, while the index b denotes the individual reconstruction blocks. n(j, N_{b}, t, m) is the regularization parameter.

4. Reconstruct single channel image by using equation 1 and the calculated weights;

5. This process is repeated for each coil in the array, resulting in N_{c} uncombined single coil images that can then be combined using a conventional sum-of-squares reconstruction or another optimal array combination.

The overall process can be viewed as just GRAPPA with one additional constraint term. The reconstruction time is comparable to GRAPPA. The regularization parameter is automatically calculated during fitting without any complicated calculation. Hence, this process can be referred to as a parameter free regularization technique. This technique can be combined with image support reduction technique.

Doubly Calibrated GRAPPA (db-GRAPPA)

Another embodiment can involve double calibration. Doubly calibrated GRAPPA is used to illustrate such double calibration. Self-calibrated PPI need extra ACS lines for calibration. The acquisition of ACS lines reduces the net reduction factor. If data from a pre-scan is available, the calibration information can be generated from this data and the acquisition of ACS lines is not necessary. Hence, the net reduction factor can be increased. However, the pre-scan image and the true image may be different because of motion. This motion can generate wrong regularization information and cause errors in the final reconstruction. This problem can be reduced by using a double calibration technique.

A specific embodiment of the invention relates to doubly calibrated GRAPPA where pre-scan data is acquired by using the same acquisition parameters as the true acquisition, but in low-resolution only. In the true scan, a small (≧R−1, where R is the reduction factor) number of ACS lines are acquired for the second calibration. With the pre-scan, the GRAPPA convolution kernels can be calculated. These GRAPPA convolution kernels are used as the basis to approximate the convolution kernels for the true scan with the small amount of ACS lines. A specific embodiment of this method can be implemented by performing the following in k-space:

Step 1. First calibration: Generate GRAPPA convolution kernels from pre-scan data \hat{K}^{j};

Step 2. Second calibration: Using both of the pre-scan k-space data \hat{K}^{j}, initial GRAPPA convolution kernels \hat{n}(j, b, t, m) from the pre-scan, and the partial k-space data from each channel to fit the ACS lines to calculate weights and using the same set of weights for reconstruction. The fitting equation is

$${K}^{j} ( {k}_{y} - m Δ {k}_{y} ) = {\sum }_{t = 1}^{{N}_{c}} ( \begin{matrix}λ ( j , t , m ) {\sum }_{b = 0}^{{N}_{b} - 1} \hat{n} ( j , b , t , m ) {K}^{j} ( {k}_{y} - bR Δ {k}_{y} ) + \\ n ( j , {N}_{b} , t , m ) {\hat{K}}^{j} ( {k}_{y} - m Δ {k}_{y} )\end{matrix} ) . \qquad [ 3 ]$$

In equation 3, the adjustment weights λ(j, t, m) for block weights from channel t and the weights n(j, N_{b}, t, m) for regularization are calculated by fitting ACS lines. In equation 2, there are N_{c}×N_{b} unknowns. But in equation 3, there are N_{c}×2 unknowns. With the reduced number of unknowns, the number of ACS lines can be dramatically reduced;

Step 3: Reconstruct single channel image by using equation 3 and the calculated weights;

Step 4: This process is repeated for each coil in the array, resulting in N_{c} uncombined single coil images that can then be combined using a conventional sum-of-squares reconstruction or another optimal array combination.

This technique adjusts the convolution kernel and regularization parameter with the self-calibration data. Hence the registration problem of the pre-scan and the true acquisition can be partially solved. Db-GRAPPA can also be combined with image support reduction technique. The same high pass filter should be applied for both the pre-scan and the true acquisition data.

### Image Ratio Constrained Reconstruction (IRCR)

Pixel-wise ratio between the calibration image and the reconstructed image can be used as the constraint for reconstruction. With this technique, the ratio between high-resolution images is approximated by the ratio between the corresponding low-resolution images. Because non-Cartesian trajectories inherently contain dense central k-space samples, this Image Ratio Constrained Reconstruction (IRCR) is suitable for the reconstruction of partially acquired non-Cartesian data, once one set of fill k-space data is available for calibration.

For calibration, in addition to a set (or sets) of partially acquired k-space data PK, a set of fully acquired k-space data RK are used. This data set can be pre-acquisition, or can be a combination of several time frames in the case of dynamic imaging. With the same under-sampling scheme as the scheme for PK, a set of partial k-space data PRK can be generated from RK. By using grids, three images IPK, IRK, and IPRK can be generated with PK, RK, and PRK, respectively. Then the reconstructed image IRec=IPK×IPRK÷IRK, where × and ÷ denote pixel-wise multiplication and division, respectively. To avoid residual aliasing, a low pass filter can be used after gridding. To avoid singularity, a specific threshold can be chosen before division.

### EXAMPLES

### Data Acquisition

To compare GRAPPA and hp-GRAPPA. high-resolution axial brain anatomy data were collected on a 3T GE system (GE Healthcare, Waukesha, Wis., USA) using the Ti FLAIR sequence (FOV 220 mm, matrix size 512×512, TR 3060 ms, TE 126 ms, flip angle 90°, Slice thickness 5 mm, number of averages 1) with an 8-channel head coil (Invivo Corporation, Gainesville, Fla., USA). PE direction was anterior-posterior.

To demonstrate the performance of embodiments of the subject method with good g-factor, one additional data set is used. This data set is for oblique cardiac images, collected on a SIEMENS Avanto system (FOV 340×255 mm, matrix 192×150, TR 20.02 ms, TE 1.43 ms, flip angle 46°, slice thickness 6 mm, number of averages 1) using a cine true FISP sequence with a 32-channel cardiac coil (Invivo Corp, Gainesville, Fla.). There are 12 images per heartbeat and the PE direction is also anterior-posterior. Because more elements are available and there are elements on both the anterior and posterior side, the g-factor of the coil is low and better performance from PPI techniques is expected.

To demonstrate the performance of embodiments of the subject method with non-Cartesian trajectory, High-resolution phantom image was acquired with an 8-channel coil and radial trajectory on a SIEMENS Avanto system. The full k-space data have 512 projections (PR), and 512 read outs. The second data set was a set of cardiac function cine images (16 time frames). Data were acquired with a 4-channel coil on a SIEMENS Avanto system, matrix size 256 (PRs)×256 (readouts)×4 (channels)×16 (time frames). To simulate the partial acquisition, time-interleaved 32 PRs from each time frame were used for reconstruction. The size of the reconstructed images were 256×256.

Although full k-space data is acquired, only the partial k-space data is used for reconstruction. If one line is used out of every R lines (excluding the central ACS lines), then the reduction factor is R by definition. The net reduction factor is defined as the ratio of the total number of PE lines to the number of PE lines used for reconstruction (including the central ACS lines).

To evaluate the image quality of the reconstructed images, difference map and relative error are used. The difference map depicts the difference in magnitudes between the reconstructed and reference-images at each pixel. It shows the distribution of error. The relative error or relative energy difference is defined as the ratio of the square root of the sum of squares of the difference map to the square root of the sum of squares of the reference image.

Regularized SENSE (8) is used for comparison. The source code provided by the original author at his website was used as a reference. The L-curve method described in reference (8) is applied to calculate the optimized parameter. However, it is difficult to be certain that the selected parameter value is the best possible for the particular application. Because the optimization is based on the calculation of error, there is no direct quantitative way to evaluate spatial resolution. Instead, the spatial resolution is protected by minimizing Model error, which is often high when reduction factor is high. Hence, the “optimized” parameter often weights the regularization term more and produces a low-resolution image. Sensitivity maps used in these two algorithms are calculated with the low-resolution images generated with the calibration signal. The sensitivity map is defined as the division of individual low-resolution image and the square root of sum-of-squares. No further steps are necessary to refine the sensitivity maps. To strictly follow the implementation described in reference (8), regularized in vivo SENSE (5), which is used in reference (8), is also implemented, i.e. the low-resolution images themselves are used as sensitivity maps. This technique has its advantages when there are minor changes between the calibration image and the true image.

For GRAPPA implementation, the size of convolution kernel is 4×5. To test the double calibration technique, the central k-space data from adjacent time frame are used as the simulated pre-scan. Then the calibration information from the pseudo-pre-scan is applied to reconstruct other time frames. The ACS lines used for the second calibration are used in final reconstruction in all reconstruction methods. In an embodiment, this can be implemented by following the reference (19), which is hereby incorporated by reference in it's entirety. The definition of parameters of the filter used in hp-GRAPPA are fixed. The value of c equals to the minimum of 13 and a quarter of the number of ACS lines, and w equals to 2.

For the purposes of this example, all methods are implemented in the MATLAB® programming environment (MathWorks Inc., Natick, Mass.). The MATLAB® codes are run on an hp workstation (xw4100) with two 3.2 GHz CPU and 2 GB RAM.

There are three sets of examples provided below. The first set shows the results of hp-GRAPPA. The results of hp-GRAPPA are compared with those by GRAPPA. The second set demonstrates the performance of db-GRAPPA. The third set demonstrates the performance of the db-GRAPPA with non-Cartesian trajectory.

### Example Set 1

### bp-GRAPPA

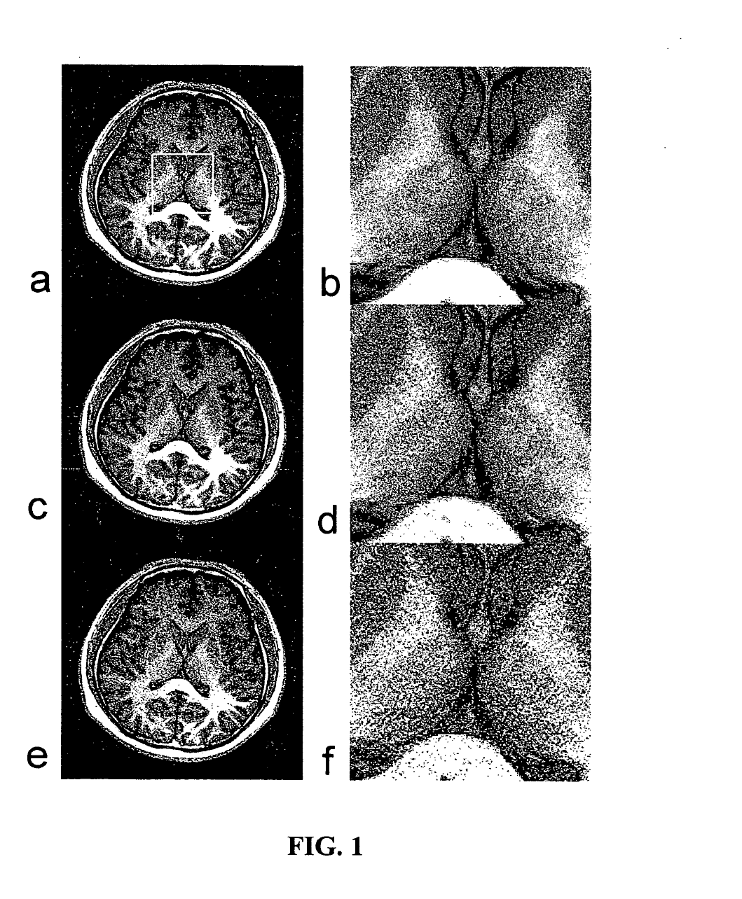

In this example, hp-GRAPPA was applied to brain images. FIG. 1 shows the results of an axial slice acquired with an 8-channel coil. The acceleration factor was 4, with 56 ACS lines; the net reduction factor was 3. FIG. 1A shows the reference image. The right columns show the zoomed-in version of the region identified by the white boxes in FIG. 1A. The results of GRAPPA (FIGS. 1E and 1F) depict excess noise. The errors in the results of hp-GRAPPA (FIGS. 1C and 1D) are moderate. The relative errors were reduced from 13% (axial) to 9% (axial). From the zoomed images, it is observed that the definition of boundaries and visibility of some structures are seriously damaged by noise in images reconstructed by conventional GRAPPA, but the damage is clearly reduced in the images reconstructed by hp-GRAPPA. Moreover, the spatial resolution was not reduced because of the regularization.

### Example Set 2

### db-GRAPPA with Ideal Regularization Information

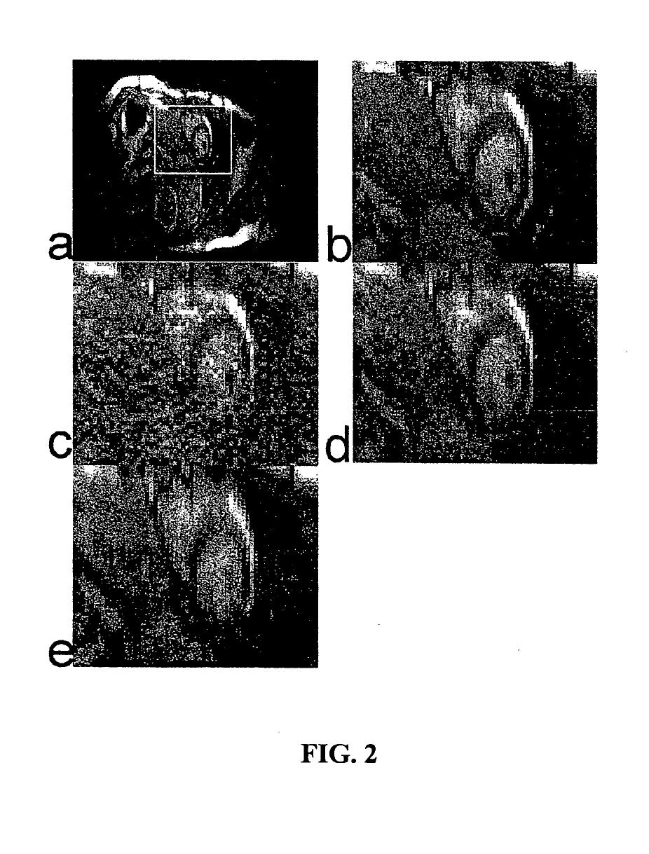

FIG. 2 and Table 1 show the comparison of several reconstruction algorithms when there is no mis-registration between prior information and the target image. The SNR of image reconstructed by the regularization algorithms with optimized parameter (FIG. 2E) is higher than those by the parameter free technique (FIG. 2D); however, this gain is achieved with a significant loss of spatial resolution. The result of db-GRAPPA (FIG. 2D) has almost identical spatial resolution as the result of GRAPPA (FIG. 2C) but has considerably less noise. With net reduction factor 3.3, db-GRAPPA can still generate images with reasonable quality. The relative errors shown in Table 1 again shows that db-GRAPPA can generate images with less relative errors than that by GRAPPA (reduced from 21.7% to 12.1% at ROI) and those by regularized methods with a carefully chosen parameter (reduced from 20.4% to 12.1% at ROI).

TABLE 1
The relative errors of reconstructions

| | | Reg S | GP | db-GP |
|---|---|---|---|---|
| 32 | error | 22.4% | 35.4% | 18.1% |
| channel | ROI | 20.4% | 21.7% | 12.1% |
| | error | | | |

RegS: Regularized SENSE; GP: GRAPPA; db-GP: doubly calibrated; GRAPPA
db-GRAPPA with Mis-Registered Regularization Information

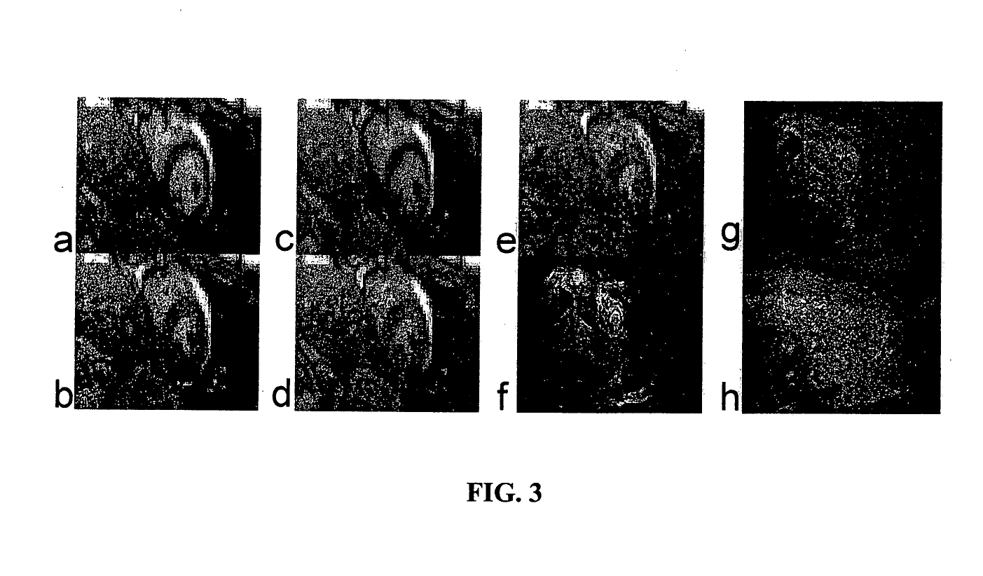

To show that db-GRAPPA can reduce the motion problem and reduce the noise level, and test the performance of this technique with high reduction factor, the cine cardiac function data acquired with 32-channel coil is used. In this experiment, the reduction factor is 6, the number of extra ACS lines is 6, and the net reduction factor becomes 4.8. The pre-scan is simulated by using 64 lines of the central k-space data of time frame 1. The pre-calibration information is calculated with the pseudo pre-scan. Then this prior information is applied to reconstruct other time frames. Similar to the previous experiment, GRAPPA with pre-calibration information uses the extra 6 ACS lines for last reconstruction. FIG. 3 shows the results of time frame 6. FIG. 3A is the zoomed region of the low-resolution image generated with the pre-calibration data. FIG. 3B is the zoomed region of the reference image. FIG. 3C is the zoomed region of the result by regularized traditional SENSE. It can be seen because of the cardiac motion, FIG. 3A cannot provide accurate regularization information for regularized SENSE. FIG. 3C has significant error at ROI. This can also be seen from the difference map (FIG. 3F) of the reference and the reconstruction of regularized SENSE. There is significant structure information in the difference map. FIG. 3D shows the zoomed in region of the result by db-GRAPPA. The structure definition in FIG. 3D is more accurate than that in FIG. 3C. From the difference map (FIG. 3G) of the result by db-GRAPPA, there is significantly less structure information than in FIG. 3F. FIG. 3E is the result by GRAPPA with convolution kernel from pre-calibration data, and FIG. 3H is the difference map. FIG. 3E has higher noise level and losses some structure information around the heart. The relative error of the reconstruction by db-GRAPPA is significantly lower than that of the reconstruction by GRAPPA (From 21.8% to 14.7%, Table 2). This experiment demonstrates that db-GRAPPA avoid error caused by the image difference between calibration image and the true image, but still enjoy the advantages of regularization.

TABLE 2
The relative errors of reconstruction with pre-calibration data

| Time frames | | RegS | Reg-iS | GP | UN-GP |
|---|---|---|---|---|---|
| 32 channel. time | Error | 10.2% | 14.3% | 11.0% | 6.7% |
| frame 6 | ROI error | 25.5% | 35.7% | 21.8% | 14.7% |

### Example Set 3

### IRCR

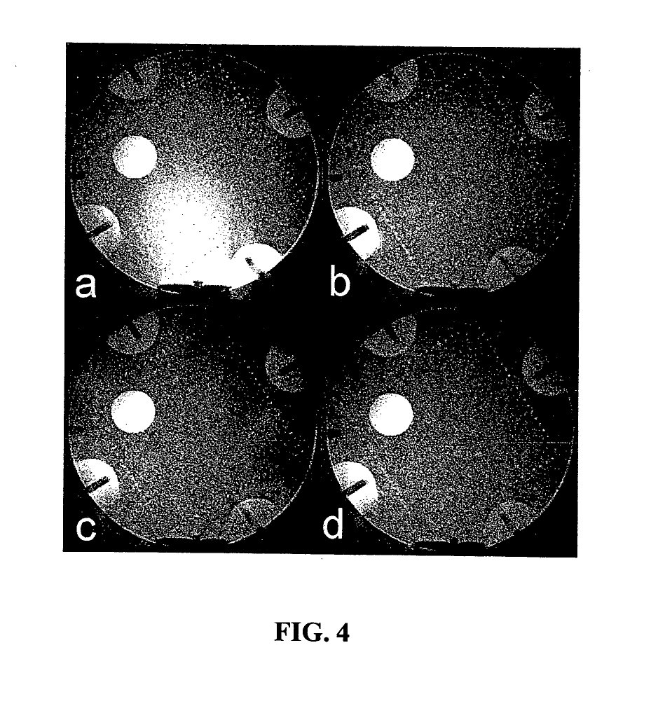

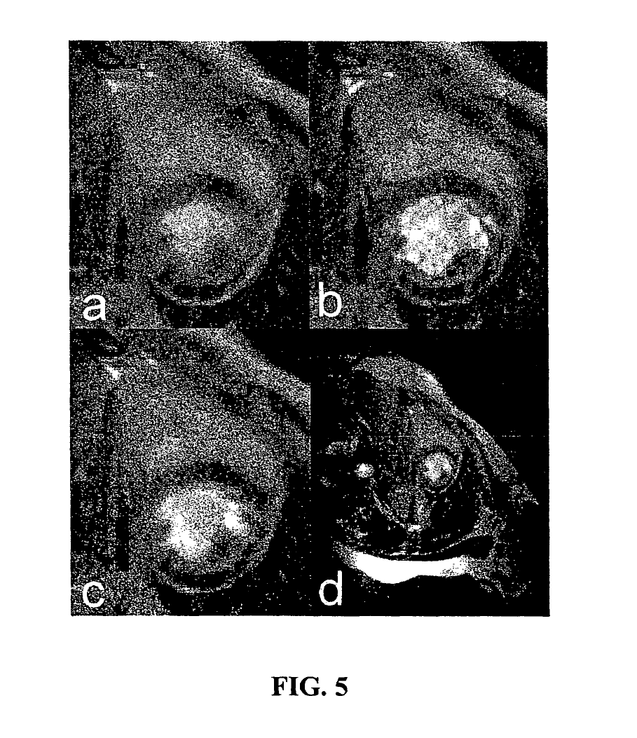

This technique is preferred when there is no geometry information change between calibration image and the reconstructed image, i.e., when there is no motion. The difference between these two images is image contrast. FIG. 4 shows an example without motion (no geometry change). High-resolution phantom image was acquired with an 8-channel coil and radial trajectory on a SIEMENS Avanto system. To simulate the difference of image contrast, the image from channel 6 is used as the calibration image to reconstruct the image from channel 5. FIG. 4a is the calibration image of channel 6. FIG. 4b is the reference image of channel 5. FIGS. 4a and 4b are reconstructed with 512 projections (PR). FIGS. 4c and 4d are images reconstructed with 8 and 16 PR. Only the region-of-interests (ROI) are shown. It can be seen that the image reconstructed with only 8 projections has the same spatial resolution as the one reconstructed with 512 PR. In addition, no obvious artifact is present. FIG. 5 shows an example with motion, e.g., with geometry change. Cardiac function cine images (16 time frames) were acquired with a 4-channel coil and radial trajectory on a SIEMENS Avanto system. Images were reconstructed channel-by-channel; no parallel imaging technique was used. Full k-space data (256 PR) of the average of all time frames in k-space along time direction were used for calibration. Each time frame was reconstructed by the IRCR with 32 PR. FIG. 5a shows the ROI of the calibration image with 256 PR. FIGS. 5b-5d show the results of time frame 13. FIG. 5b is the ROI of the reference image reconstructed with 256 PR. FIGS. 5c and 5d show the ROI and whole image region of the image reconstructed with 32 PR. It can be seen that even if there are geometry changes, the subject IRCR method can still generate high signal to noise ratio (SNR) images with some blurring at the dynamic regions.

Embodiments of reconstruction technique, using image ratio as a reconstruction constraint are not limited by the acquisition trajectory or number of channels. When there is no motion between calibration image and the desired image, high SNR and high spatial resolution image can be reconstructed with as few as 8 projections. In a specific embodiment, this technique is applied to cine phase contrast angiography.

Regularized GRAPPA with Regularization Term from IRCR for Non-Cartesian Imaging

When there are dynamic regions, the subject technique using image ratio as a reconstruction constraint can be combined with other reconstruction techniques to generate high quality images that cannot be generated with each technique individually. In an embodiment, using image ratio as a reconstruction constraint in combination with GRAPPA [22], as the regularization term, can allow parameter free regularized non-Cartesian GRAPPA.

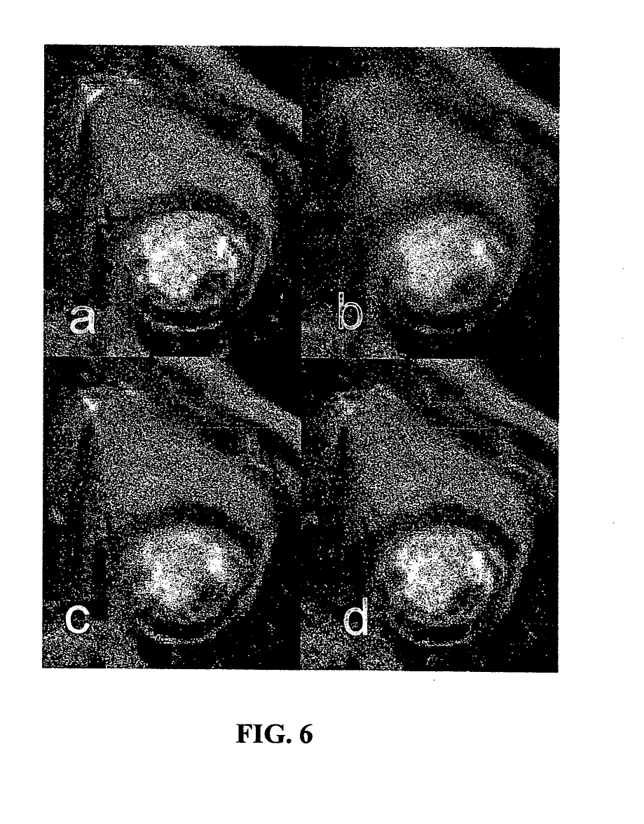

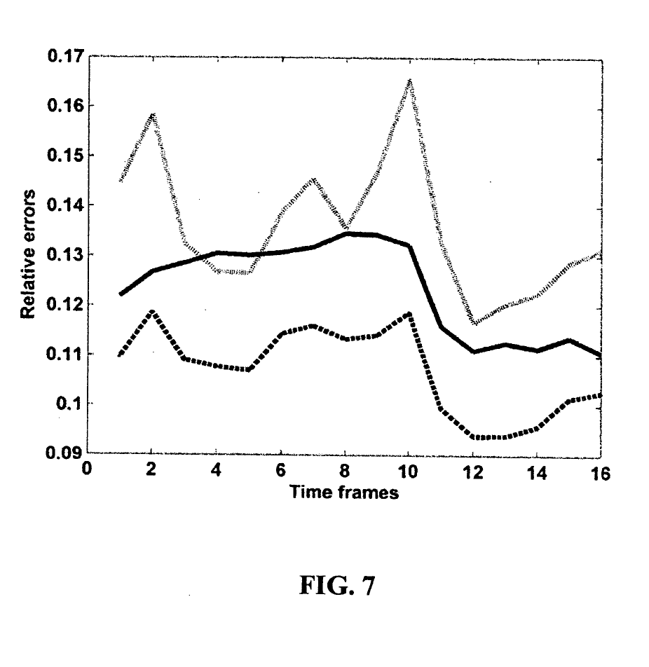

Cardiac function cine images were acquired with radial trajectory on a SIEMENS Avanto system. Matrix size is 256 (projections, PR)×512 (read out)×16 (time frames)×4 (channels). Only 32 PR from each time frame were used for reconstruction. The average, in k-space and along time direction, data (256 PR) of all time frames were used as calibration data. Images reconstructed by IRCR with 32 PR and the calibration data were used as regularization image for each time frame. Then the subject regularized GRAPPA (Eq. 2) technique was applied for final reconstruction. For comparison, GRAPPA without regularization was also applied for reconstruction. The convolution kernels for conventional GRAPPA were calculated with the calibration data. FIG. 6 shows the region of interests (ROI) of the results of time frame 13. FIG. 10a shows the reference image reconstructed with 256 PR. FIGS. 6b-6d show the image reconstructed by conventional GRAPPA, IRCR, and regularized GRAPPA. Clearly, the result obtained by regularized GRAPPA has higher spatial resolution than these by other methods. FIG. 7 shows the plot of relative errors at ROI of images reconstructed by conventional GRAPPA (solid line), IRCR (dotted line), and regularized (dashed line) of each time frame. FIG. 7 demonstrates again that the proposed regularized GRAPPA generated images with the lowest error at all time frames.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### REFERENCES

1. Sodickson D K, Manning W J. Simultaneous acquisition of spatial harmonics (SMASH): ultra-fast imaging with radiofrequency coil arrays. Magn Reson Med 1997, 38:591-603.
2. Pruessmann K P, Weiger M, Scheidegger M B, Boesiger P. SENSE: Sensitivity encoding for fast MRI. Magn Reson Med 1999, 42:952-962.
3. Griswold M A, Jakob P M, Heidemann R M, Mathias Nittka, Jellus V, Wang J, Kiefer B, Haase A. Generalized Autocalibrating Partially Parallel Acquisitions (GRAPPA). Magn Reson Med 2002, 47:1202-1210.
4. Tsao J, Pruessmann K P, Boesiger P. Feedback Regularization for SENSE Reconstruction. Intl Soc Mag Reson Med 10, 2002, p. 739.
5. Sodickson D K. Tailored SMASH image reconstructions for robust in vivo parallel MR imaging. Magn Reson Med 2000, 44:243-251.
6. Sodickson D K, McKenzie C A. A generalized approach to parallel magnetic resonance imaging. Med Phys 2001, 28:1629-1643.
7. Liang Z-P, Bammer R, Ji J, Pelc N, Glover G. Making better SENSE: wavelet de-noising, Tikhonov regularization, and total-least squares. Intl Soc Mag Reson Med 10; 2002; Honolulu, p. 2388.
8. Lin F-H, Kwong K K, Belliveau J W, Wald L L. Parallel Imaging Reconstruction Using Automatic Regularization. Magn Reson Med 2004, 51:559-567.
9. Lin F-H. Prior-regularized GRAPPA Reconstruction. Intl Soc Mag Reson Med 14, 2006, Seattle, USA, p. 3656.
10. Bydder M, Robson M D, Partial Fourier Partially Parallel Imaging, Magn Reson Med 2005, 53:1393-1401.
11. King K F, Angelos L. SENSE image quality improvement using matrix regularization. Intl Soc Mag Reson Med 9, 2001, p. 1771.
12. Kellman P, MeVeigh E R. SENSE Coefficient Calculation using Adaptive Regularization. ISMRM Workshop on Minimum MR Data Acquisition Methods, 2001, Marco island, Fla., p. 121-124.
13. Qu P, Yuan J, Wu B, Shen G X, Optimization of Regularization Parameter for GRAPPA Reconstruction, Intl Soc Mag Reson Med 14, 2006, Seattle, USA. p. 2474.
14. Hansen P C. Rank-deficient and discrete ill-posed problems: numerical aspects of linear inversion. Philadelphia: SIAM, 1998.
15. Willig-Onwuachi J D, Yeh E N, Grant A K, Ohliger M A, McKenzie C A, Sodickson D K. Phase-Constrained Parallel MR Image Reconstruction: Using Symmetry to Increase Acceleration and Improve Image Quality. Intl Soc Mag Reson Med 11, 2003, Toronto, Canada, p. 19.
16. Huang F, Duensing G R, Akao J, Limkeman M. A k-space implementation for image support minimization to improve parallel imaging performance in dynamic imaging. Intl Soc Mag Reson Med 13, 2005, Miami, Fla., USA, p. 2690.
17. Huang F. Image support reduction technique for self-calibrated partially parallel imaging. Intl Soc Mag Reson Med 14, 2006, Seattle, Wash., USA, p. 2358.
18. Heidemann R M, Griswold M A, Haase A, Jakob P M. VD-AUTO-SMASH imaging. Magn Reson Med 2001, 45:1066-1074.
19. Wang J, Kluge T, Nittka M, Jellus V, Bemd Kühn, Kiefer B. Parallel Acquisition Techniques with Modified Sense Reconstruction mSense. First Wurzburg workshop on: Parallel Imaging Basics and Clinical Applications, 2001, Wurzburg, Germany, p. 92.
22. Griswold M et al., MRM 2002, 47:1202-1210.
23. Griswold, M. A, et. al., ISMRM 2003, p. 2349.
24. Huang, F, ISMRM Flow and Motion, 2006, New York.
25. Griswold, M. A et al., MRM 2002, 47:1202-1210.

1. A method of reconstructing an image, comprising:
a. receiving prior information corresponding to a first time period;
b. receiving a partial k-space data set corresponding to an image corresponding to a second time period, wherein the second time period is different from the first time period, wherein the partial k-space data set includes a plurality of ACS lines;
c. projecting the prior information into k-space to generate an initial full k-space data \hat{K}^{j};
d. calculating a regularization parameter by data-fitting the ACS lines using both of the prior information and the partial k-space data set; and
e. reconstructing an image from the partial k-space data set.

2. The method according to claim 1, wherein the partial k-space data set comprises at least 20 ACS lines.

3. The method according to claim 1, wherein the partial k-space data set comprises at least 30 ACS lines.

4. The method according to claim 1, wherein the prior information and the partial k-space data set comprise data for a plurality of magnetic resonance imaging coils.

5. The method according to claim 4, wherein fitting data in coil j at a line k_{y}−mΔk_{y} offset from the normally acquired data comprises
$${K}^{j} ( {k}_{y} - m Δ {k}_{y} ) = {\sum }_{t = 1}^{{N}_{c}} ( \begin{matrix}{\sum }_{b = 0}^{{N}_{b} - 1} n ( j , b , t , m ) {K}^{j} ( {k}_{y} - bR Δ {k}_{y} ) + \\ n ( j , {N}_{b} , t , m ) {\hat{K}}^{j} ( {k}_{y} - m Δ {k}_{y} )\end{matrix} ) ,$$
N_{b} is the number of blocks used in the reconstruction, where a block is defined as a single acquired line and R−1 missing lines, wherein n(j, b, t, m) is generated by fitting the ACS lines, represents the weights used in this now expanded linear combination, where index t denotes the individual coils, index b denotes the individual reconstruction blocks, and n(j, N_{b}, t, m) is the regularization parameter;

6. The method according to claim 4, wherein reconstructing the image comprises reconstructing a single coil image using
$${K}^{j} ( {k}_{y} - m Δ {k}_{y} ) = {\sum }_{t = 1}^{{N}_{c}} ( \begin{matrix}{\sum }_{b = 0}^{{N}_{b} - 1} n ( j , b , t , m ) {K}^{j} ( {k}_{y} - bR Δ {k}_{y} ) + \\ n ( j , {N}_{b} , t , m ) {\hat{K}}^{j} ( {k}_{y} - m Δ {k}_{y} )\end{matrix} )$$
and the calculated weights; and
repeating a., b., c., d., and e. for each coil in the array, resulting in N_{c} uncombined single coil images; combining the N_{c} uncombined single coil images into a combined image.

7. The method according to claim 6, where the N_{c} uncombined single coil images are combined using a sum-of-squares reconstruction.

8. The method according to claim 6, where the N_{c} uncombined single coil images are combined using an optimal array combination.

9. The method according to claim 1, wherein the ACS lines are at the center of k-space.

10. The method according to claim 1, wherein the prior information is a full k-space set.

11. A method of reconstructing an image, comprising:
a. receiving pre-scan data \hat{K}^{j} corresponding to a first time period;
b. receiving partial k-space data corresponding to a second time period, where the second time period is different than the first time period, wherein the partial k-space data includes a plurality of ACS lines;
c. performing a first calibration, wherein performing the first calibration comprises generating initial GRAPPA convolution kernels from the pre-scan data \hat{K}^{j};
d. performing a second calibration, wherein performing the second calibration comprises using both of the pre-scan k-space data \hat{K}^{j}, initial GRAPPA convolution kernels \hat{n}(j, b, t, m) from the pre-scan, and the partial k-space data to fit the ACS lines to calculate weights; and
e. reconstructing an image from the partial k-space data.

12. The method according to claim 11, wherein the pre-scan data \hat{K}^{d} and the partial k-space data comprise data for a plurality of magnetic resonance imaging coils.

13. The method according to claim 12, where the fitting equation is
$${K}^{j} ( {k}_{y} - m Δ {k}_{y} ) = {\sum }_{t = 1}^{{N}_{c}} ( \begin{matrix}λ ( j , t , m ) {\sum }_{b = 0}^{{N}_{b} - 1} \hat{n} ( j , b , t , m ) {K}^{j} ( {k}_{y} - bR Δ {k}_{y} ) + \\ n ( j , {N}_{b} , t , m ) {\hat{K}}^{j} ( {k}_{y} - m Δ {k}_{y} )\end{matrix} ) ,$$
the adjustment weights λ(j, t, m) for block weights from channel t and the weights n(j, N_{b}, t, m) for regularization are calculated by fitting ACS lines.

14. The method according to claim 12, wherein reconstructing the image comprises reconstructing single coil image using
$${K}^{j} ( {k}_{y} - m Δ {k}_{y} ) = {\sum }_{t = 1}^{{N}_{c}} ( \begin{matrix}λ ( j , t , m ) {\sum }_{b = 0}^{{N}_{b} - 1} \hat{n} ( j , b , t , m ) {K}^{j} ( {k}_{y} - bR Δ {k}_{y} ) + \\ n ( j , {N}_{b} , t , m ) {\hat{K}}^{j} ( {k}_{y} - m Δ {k}_{y} )\end{matrix} )$$
and the calculated weights; and
repeating a., b., c., d., and e. for each coil in the array, resulting in N_{c} uncombined single coil images combining the N_{c} uncombined single coil images into a combined image.

15. The method according to claim 14, wherein the he N_{c} uncombined single coil images are combined using a sum-of-squares reconstruction.

16. The method according to claim 15, wherein the he N_{c} uncombined single coil images are combined using an optimal array combination.

17. The method according to claim 11, wherein the number of ACS lines is greater than or equal to R−1, where R is the reduction factor.

18. The method according to claim 11, wherein the pre-scan data \hat{K}^{v} is low resolution.

19. The method according to claim 12, wherein receiving partial k-space data comprises receiving partial k-space data from each coil.

20. The method according to claim 17, wherein the number of ACS lines is R−1.

21. A method of reconstructing an image, comprising:
receiving a partial k-space data set corresponding to an image, using a portion of the partial k-space data set as prior information;
creating a low-resolution image from the prior information;
passing the partial k-space data set through a high-pass filter in k-space; wherein the high-pass filter suppresses a low frequency portion of the partial k-space data set;
applying GRAPPA to the high-pass filtered k-space data set to fill in the high-pass filtered k-space data set;
passing the filled in high-pass filtered k-space data set through a second filter that is the inverse of the high-pass filter; and
producing an image from the k-space data set filtered by the second filter.

22. The method according to claim 21, wherein producing an image from the k-space data filtered by the second filter comprises replacing portion of the k-space data prior to producing the image.

23. The method according to claim 21, where 1-FK is used as the high-pass filter, where
$$FK = {( 1 + {e}^{( \sqrt{{k}_{x}^{2} + {k}_{y}^{2}} - c ) / w} )}^{- 1} - {( 1 + {e}^{( \sqrt{{k}_{x}^{2} + {k}_{y}^{2}} + c ) / w} )}^{- 1} ,$$
where k_{y} is the count of phase encode lines, where c sets the cut-off frequency, and w determines the smoothness of the filter boundary.

24. The method according to claim 23, wherein c is the lower of 13 and a quarter of the number of ACS lines and w is 2.

25. The method according to claim 21, wherein the high-pass filter suppresses a portion of the partial k-space data set used as prior information.

26. A method of generating prior information for use in reconstructing an image, comprising:
a. acquiring a first data set for a first portion of fall k-space for a first time period;
b. acquiring at least one additional data set for a corresponding at least one additional portion of full k-space for a corresponding at least one additional time period, wherein each additional portion covers a subset of k-space that is different from the subset of k-space covered by the additional portions and different from the subset of k-space covered by the first portion;
c. acquiring a full k-space data set;
d. creating a composite image, I_{c}, from the full k-space data set;
e. selecting a first center portion data set from the first data set such that the first center portion data set is from low-frequency k-space and the first center portion data set is full within the first center portion;
f. creating a first low-resolution image, L₁, from the first center portion data set;
g. selecting a composite center portion data set of the full k-space data set, wherein the composite center portion data set covers the same center portion of k-space covered by the first center portion data set;
h. creating a composite low-resolution image, L_{c}, from the composite center portion data set;
i. reconstructing a first image, I₁, according to the relation I₁=L₁/L_{c}*I_{c}.

27. The method according to claim 31, wherein the k-space data is acquired via spiral encoding.

28. The method according to claim 31, further comprising:
reconstructing a corresponding at least one additional image, Iᵢ, according to the relation I₁=Lᵢ/L_{c}*I_{c}, where Lᵢ is the ith at least one additional low-resolution image.

29. The method according to claim 31, wherein the k-space data is acquired via radial encoding.

30. The method according to claim 29, wherein the first portion of full k-space is a first plurality of trajectories, wherein each additional portion of full k-space is a corresponding additional plurality of trajectories rotated, wherein the corresponding additional plurality of trajectories is rotated with respect to the first pluralities of trajectories.

31. The method according to claim 30, wherein the first plurality of trajectories and the additional pluralities of trajectories fill k-space.

32. The method according to claim 28, wherein the images I₁ and Iᵢ are angiography images.
